(19) United States
(12) Patent Application Publication
(10) Pub. No.: US 2024/0330308 A1
(43) Pub. Date: Oct. 3, 2024

(54) SYSTEM STATE ADAPTIVE WORKLOAD PLACEMENT AND REQUEST ROUTING USING SEARCH TECHNOLOGY

(71) Applicant: International Business Machines Corporation, Armonk, NY (US)

(72) Inventors: Uwe Karl Hansmann, Tuebingen (DE); Timo Kussmaul, Boeblingen (DE)

(21) Appl. No.: 18/191,236

(22) Filed: Mar. 28, 2023

(51) Int. Cl. G06F 16/2457; G06F 16/22

(52) U.S. Cl. CPC G06F 16/24575; G06F 16/2272

(57) ABSTRACT

An adaptive workload placement and service request routing while ensuring that information relating to a current system state remains confidential. A search index representing a current system state and context is built and a set of service instances is received. The set of service instances are then associated with a set of search queries that are run against the search index, with the running of the set of search queries against the search index producing a set of scored search results. Each scored search result is associated with a service instance. The service instance associated with the highest scored search result is selected, and a service request is routed to the selected service instance.

### BACKGROUND

The present invention relates generally to the field of workload placement and service request routing, and more particularly to an efficient manner in which to route service requests and/or workloads on an enterprise-level scale.

### SUMMARY

According to an aspect of the present invention, there is a method, computer program product and/or computer system that performs the following operations (not necessarily in the following order): (i) determining a search index and a plurality of service instances based, at least in part, upon using a set of system state aware logs that includes information indicative of a current system state and a current system context; (ii) associating a service instance of the plurality of service instances to at least one search query; (iii) running the at least one search query against the search index, with the running of the at least one search query against the search index producing a scored search result; (iv) responsive to the running of the at least one search query against the search index, selecting the search query producing the highest score; and (v) routing a service request to the service instance corresponding to the selected search query.

### BRIEF DESCRIPTION OF THE DRAWINGS

FIG. 1 depicts a cloud computing node used in a first embodiment of a system according to the present invention;

FIG. 2 depicts an embodiment of a cloud computing environment (also called the “first embodiment system”) according to the present invention;

FIG. 3 depicts abstraction model layers used in the first embodiment system;

FIG. 4 is a flowchart showing a first embodiment method performed, at least in part, by the first embodiment system;

FIG. 5 is a block diagram showing a machine logic (for example, software) portion of the first embodiment system;

FIG. 6 is a first system diagram showing information that is helpful in understanding certain embodiments of the present invention;

FIG. 7 is a second system diagram showing information that is helpful in understanding certain embodiments of the present invention; and

FIG. 8 is a system flow diagram showing information that is helpful in understanding certain embodiments of the present invention.

### DETAILED DESCRIPTION

Some embodiments of the present invention are directed towards an adaptive workload placement and service request routing while ensuring that information relating to a current system state remains confidential. A search index representing a current system state and context is built and a set of service instances is received. The set of service instances are then associated with a set of search queries that are run against the search index, with the running of the set of search queries against the search index producing a set of scored search results. Each scored search result is associated with a service instance. The service instance associated with the highest scored search result is selected, and a service request is routed to the selected service instance.

This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

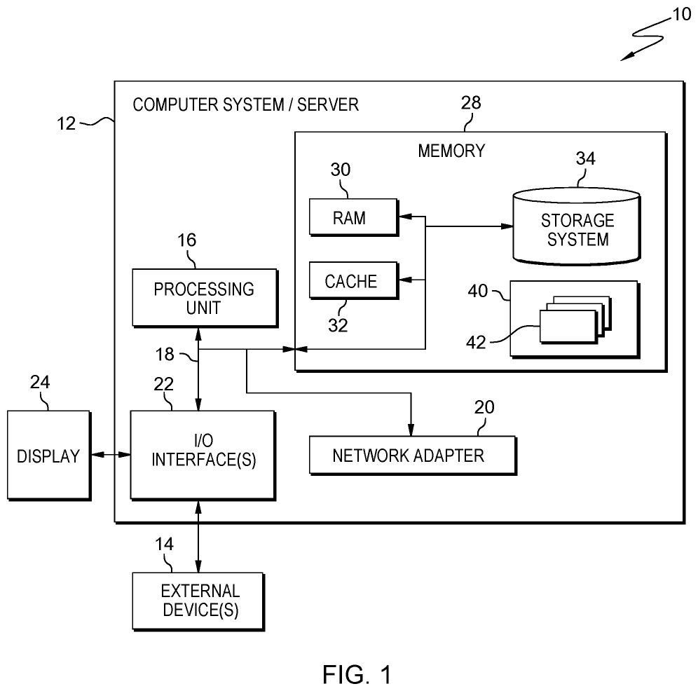

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

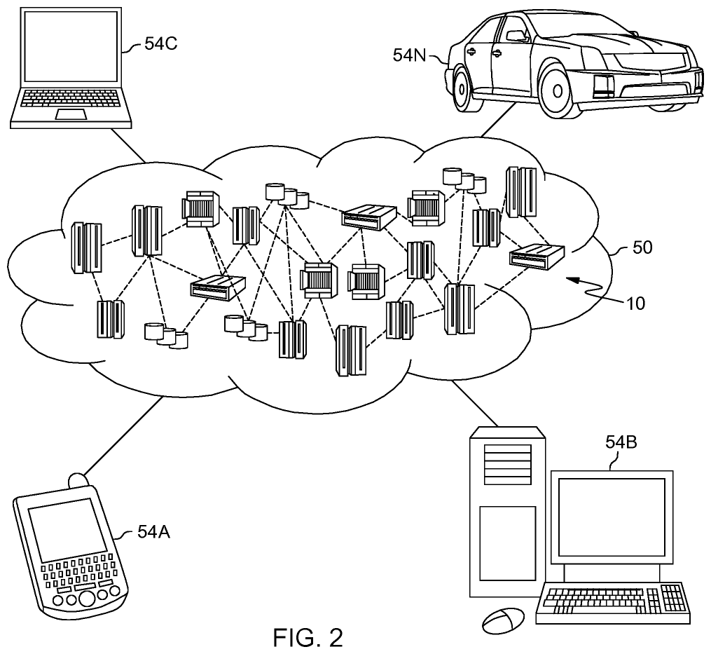

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

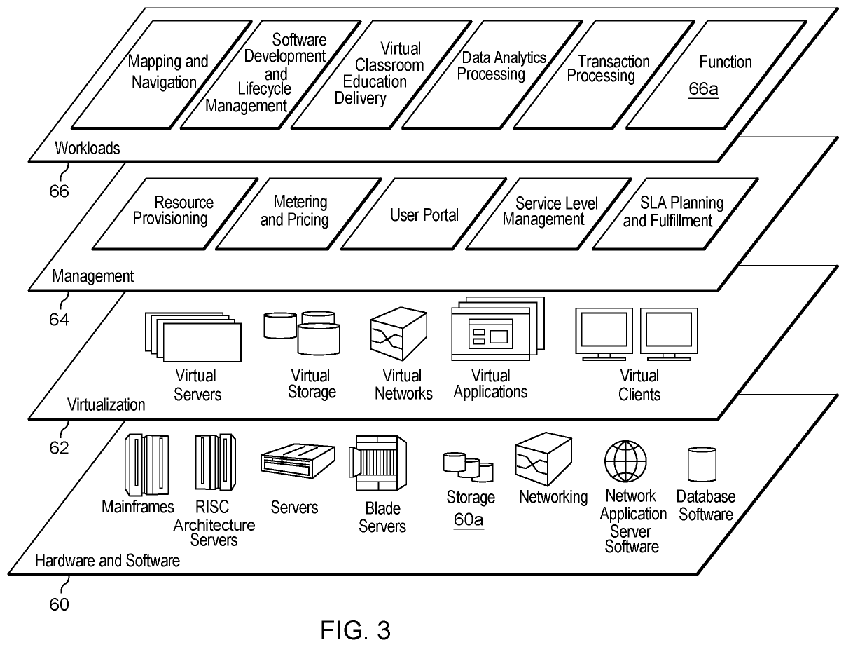

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes; RISC (Reduced Instruction Set Computer) architecture based servers; storage devices; networks and networking components. In some embodiments software components include network application server software.

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and functionality according to the present invention (see function block 66a) as will be discussed in detail, below, in the following sub-sections of this Detailed description section.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

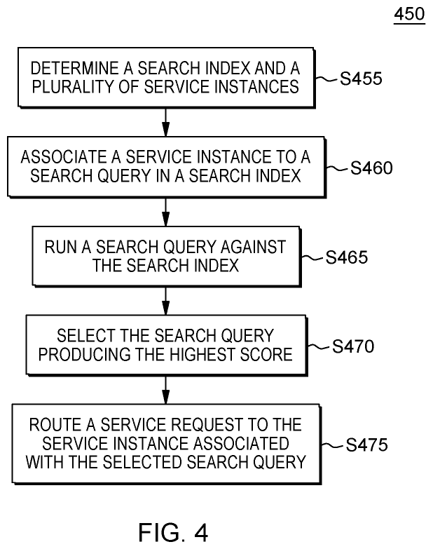

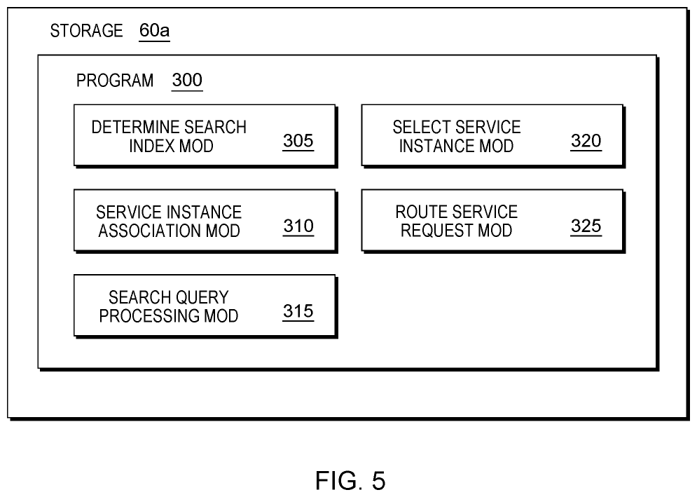

FIG. 4 shows flowchart 450 depicting a method according to the present invention. FIG. 5 shows program 300 for performing at least some of the method operations of flowchart 450. This method and associated software will now be discussed, over the course of the following paragraphs, with extensive reference to FIG. 4 (for the method operation blocks) and FIG. 5 (for the software blocks). One physical location where program 300 of FIG. 5 may be stored is in storage block 60a (see FIG. 3).

Processing begins at operation S455, where determine search index module (“mod”) 305 determines a search index and a plurality of service instances. In some embodiments of the present invention, determine search index mod 305 builds a search index by ingesting data logs that contain information relating to a current state of the system (for example, a data log can provide information about whether the system is currently experiencing a service outage, when the last service outage occurred, whether the system is currently overloaded and cannot handle service requests in a timely manner, etc.). Additionally, in some embodiments, mod 305 receives multiple instances of a deployment service or microservices (also referred to as a set of service instances) of service instances.

Processing proceeds to operation S460, where service instance association mod 310 associates a service instance (discussed in connection with operation S455, above) to at least one search query in a search index. In some embodiments of the present invention, service instance association mod 310 performs a one-to-one association between one service instance and one search query. Alternatively, mod 310 makes a multiple-to-one association between at least one service instance to multiple search queries.

Processing proceeds to operation S465, where search query processing mod 315 runs the search query against the search index. Additionally, in some embodiments, search query processing mod 315 produces a numerical score for the search query (referred to herein as a “scored search result”). In some embodiments, the numerical score that is produced for each search query is indicative of the degree to which an execution environment is relatively problematic for processing the service instance that is associated with a given scored search query.

Processing proceeds to operation S470, where select service instance mod 320 selects the search query producing the highest score. In some embodiments, search query processing mod 315 can run the search query (or set of search queries) against the search index for a second time (or multiple times). This additional run (or runs) produces a new set of scored search results, and this new set of scored search results can sometimes differ from the scores produced in the original run. In the instance where the scored search results from the subsequent runs differ from the scored search results in the original run, select service instance mod 320 selects the search query producing the highest score from the latest run in order to ensure that the execution environment that is selected to process the service instance is the most optimal environment.

Processing finally proceeds to operation S475, where route service request mod 325 routes a service request to the service instance corresponding to the selected search query.

### III. Further Comments and/or Embodiments

Embodiments of the present invention provide a novel method for adaptive workload placement and request routing (that is, routing a workload placement request or a service request to one of multiple instances of a deployment service or a micro service in a cloud or on premises environment). It is important to note that this perspective applies embodiments of the present invention to both workload placement use cases and (micro) service request routing use cases.

This type of smart and adaptive routing may take place in an edge-based system, in a cloud infrastructure, in intermediaries located on premises, in cloud-like load balancers, API gateways, etc.

Typically, workload placement and request routing needs to be context and state aware and needs to adapt to the system state. For example, the cloud should not route a workload placement request to deployment service instances in environments that are in an error state, overloaded, can be predicted to be overloaded soon, etc. In addition, other legal, contractual, business or service level agreement (SLA) related constraints for routing a workload placement request to one of multiple execution environments, data centers, locations, etc. may be in place and needs to be considered by the router.

Embodiments of the present invention aims to answer the following question: How can a system state and context aware request routing be implemented in an efficient and flexible manner while keeping sensitive system state related information confidential?

In some embodiments, a method for system state and context aware and/or context adaptive routing of a service request (including workload placement requests and service invocation requests) to one of multiple (deployment or micro-) service instances (such as in a cloud environment) is provided.

This method includes operations such as the following (and not necessarily in the following order): (i) determining a search index that represents the current system state and context (for example, one that is built by an ELK stack or log management framework from logs gathered from the system components); (ii) determining a set of service instances; (iii) associating each service instance with a set of search queries; (iv) optionally adapting the search queries by the router in a context and tenant-specific way; (v) running the search queries against the search index, thereby creating a set of scored search results, where each search result is associated with a service instance; (vi) selecting the service instance associated with the highest scored search results; and (vii) routing the service request to the selected service instance.

Embodiments of the present invention is based on search technology and leverages prior art such as the ELK stack, where the system state and context are represented in at least one corpus resp. search index. In prior art instances dealing with the ELK stack, at least one search index is typically built and aggregated from logs of the various subsystems, service instances, infrastructure components, etc. Accordingly, the system state or a situation like a temporary or permanent service outage, performance problems of a node, and/or other database errors are represented in the search index. The ELK stack typically provides the tools to show these situations to an operator or administrator, but is not integrated with request routing (as used in the prior art). As used throughout this document, the term “ELK” is an acronym for three open source software tools: Elasticsearch, Logstash, and Kibana. (Note: the terms “ELASTICSEARCH,” “LOGSTASH,” AND “KIBANA” may be subject to trademark rights in various jurisdictions throughout the world and are used here only in reference to the products or services properly denominated by the marks to the extent that such trademark rights may exist).

There are prior art methods for routing a service request to a target execution environment that are based on search technology. However, these methods typically require maintaining dedicated and separate search indexes that include execution environment metadata. These search indexes also do not provide an up-to-date representation of the current state of the system, but typically include static metadata only and typically need to be created and managed separately from prior art ELK stacks. Therefore, these prior art routing mechanisms are not system state aware.

In contrast, embodiments of the present invention can reuse prior art ELK stack search indexes (or similar log collection environments) for enabling automatic and adaptive system state aware routing of service requests. Since these search indexes are created from current log entries, these search indexes provide an up-to-date representation of the current state and context of the entire system. This way, embodiments of the present invention can realize system state and context aware request routing.

Additionally, through the use of certain embodiments of the present invention, it is not necessary to create and maintain separate search indexes. This minimizes costs, potential failures, errors, redundancies, and/or inconsistencies.

In some instances, because the information in the search index related to current system state and context may be sensitive, it is important to note that embodiments of the present invention can be implemented in the existing boundaries of a prior art ELK stack and does not need to distribute or otherwise expose the information from the search index to other potentially less secure environments.

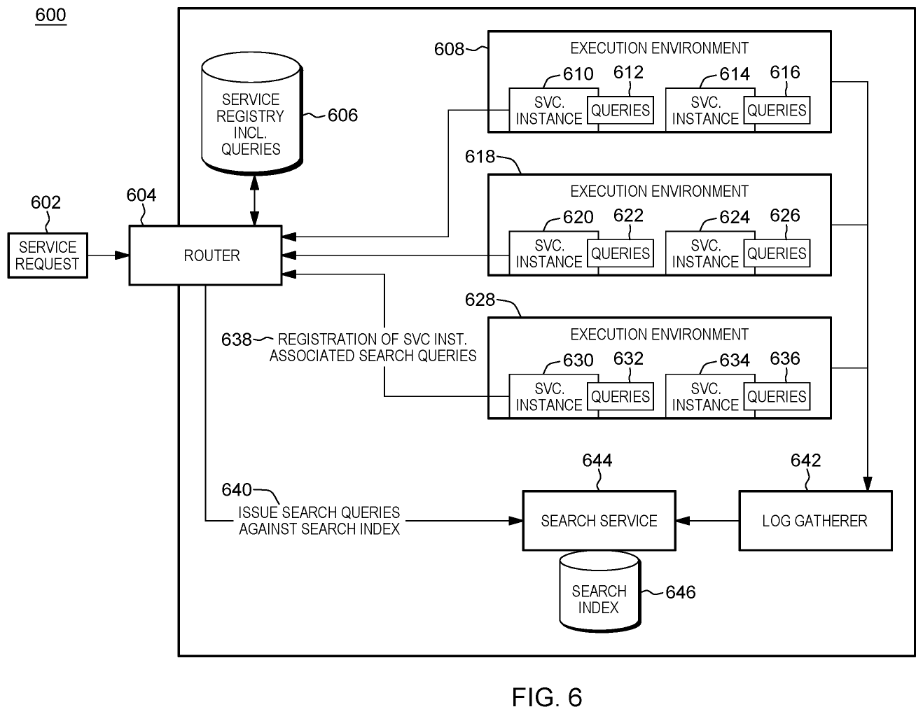

Characteristics of at least one embodiment of the present invention is shown in system diagram 600 FIG. 6. System diagram 600 includes the following components: service request 602, router 604, service registry 606, execution environment 608 (including service instance 610, search queries 612, and service instance 614 and search queries 616), execution environment 618 (including service instance 620, search queries 622, service instance 624 and search queries 626), execution environment 628 (including service instance 630, search queries 632, service instance 634 and search queries 636), service instance registration 638, issue search queries against search index 640, log gatherer 642, search service 644, and search index 646).

Multiple instances of one service can be deployed into a set of execution environments.

With embodiments of the present invention, a service instance is associated with a set of search queries. In one embodiment, the service implementation creates these search queries for each service instance.

In an alternative embodiment, an environment specific query adaptation component adapts the search queries. This adaptation is done either independent of or in cooperation with the service instances.

The service instance registers itself at the router. The prior art registration process is extended to include the search queries associated with the search query. To do so, the registration provides an API to pass the set of search queries for a service instance. In some embodiments of the present invention, the router performs several actions, including: (i) maintains a registry of all registered service instances including associated search queries; (ii) receives a service request and is responsible to route it to a specific service instance; (iii) determines at least one (prior art) search index representing the system state and includes the system log files gathered by a prior art log gatherer; (iv) determines all service instances for the requested service (using a prior art lookup method); and (v) determines the set of search queries for each of the selected service instances and issues these search queries against the determined search index.

In some embodiments, a router subcomponent for query adaptation adapts and/or augments the search queries in a context and tenant-specific way. One way in which the router component can adapt and/or augment the search queries is by adding a filter query to limit the scope of the query to a tenant, a certain timeframe, etc.

In some embodiments, the router subcomponent receives the search results for each search query, with the search query including at least one score. It is important to note that the search queries can be designed and verified to not return any potentially sensitive data, but only to aggregate like result counts, scores, and anonymous data such as IDs. As a result, potentially sensitive data will not be returned to the router, and embodiments of the present invention work as designed.

In some embodiments, the router ranks the service instances according to the search result score of their associated search queries. Additionally, the router routes the service request to the top-ranked service instance.

In one embodiment, an example service uses DB2 and requires DB2 to be available without errors.

In order to avoid error situations, routing mechanisms of embodiments of the present invention need to avoid routing requests to service instances that are experiencing DB2 errors. It is important to note that the router implementation does not have any knowledge about the workings and requirements of the service instances but relies on the loose coupling mechanism to select the appropriate service instances.

Additionally, embodiments of the present invention leverage existing search indexes that include logs of all execution environments, including the following: (i) error messages (including DB2 and SQL errors); and (ii) items in the search index that include a field “svcid” that includes the identification of the service instance that created the log statement.

Through the use of embodiments of the present invention, the service implementation creates a set of search queries and provides these search queries via the registration API to the router.

Shown below is a list of the subqueries in simplified “Solr”—a pseudo syntax (much more and complex search functionality is available in existing search engines like Solr and Elastic Search). These subqueries are assembled in one example search query, shown here:
- -“DB2 SQL Error”
“DB2 Error”
- -“SQLCODE”
-q=”status:ok”
-“fq=svcids:<svcid1>, <svcid2>, <svcid3>”

In some embodiments, when receiving a service request, the router will run the registered queries for the service instances of the requested service. Here, the router receives a scored search result for each registered service instance, where a high score represents that there are no DB2 related errors for the service instance.

In addition to the above example, the service implementation can add additional filters, such only looking at the logs from the last twenty (20) minutes to improve the results' quality. Accordingly, the router will select the top scored search result and route the request to the corresponding service instance.

Embodiments of the present invention include the following advantages: (i) enables automatic and adaptive system state aware service routing; (ii) leverages prior art search indexes and does not require a router to gather and maintain additional knowledge and/or data; (iii) flexible and loosely coupled search-based mechanism for service and service instance specific routing does not require router side knowledge about the service instances; (iv) does not copy, distribute, or expose the system state related information (potentially comprising sensitive logged data) outside the previously existing search index/ELK stack. This means: The invention works without exposing sensitive data to additional parties or components in comparison to prior art.

Some embodiments of the present invention can be combined with other known service instance selection and service routing methods, and these search results can be cached to improve performance.

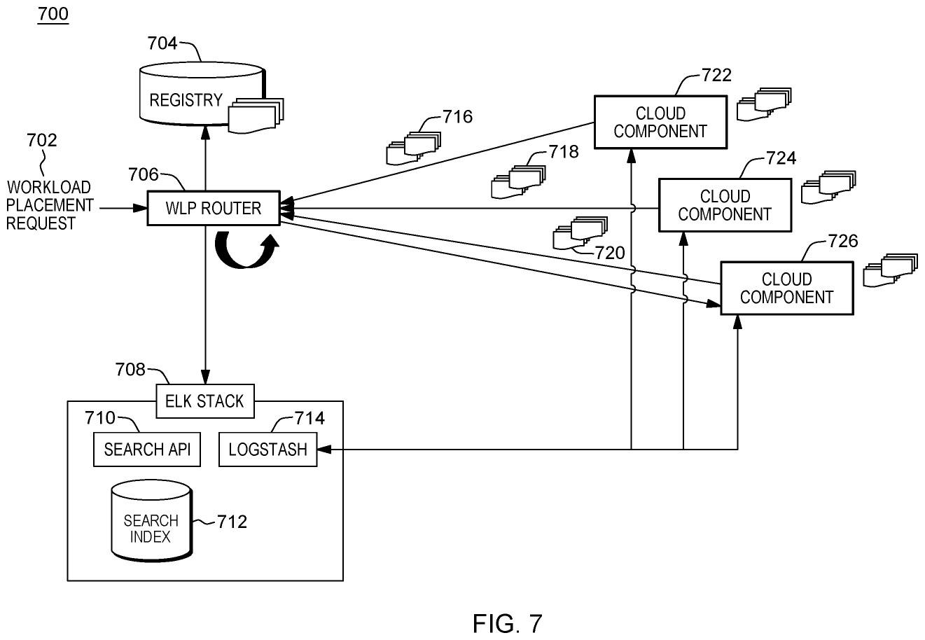

System diagram 700 of FIG. 7 depicts a workload placement base mechanism. System diagram 700 includes the following components: workload placement request 702, registry 704, WLP Router 706, ELK Stack 708, Search API 710, Search Index 712, Logstash 714, search query 716, search query 718, search query 720, cloud component 722, cloud component 724, and cloud component 726.

In some embodiments of the present invention, ELK Stack 708 and/or the ingestion pipeline (not separately shown) maintains a search index that includes a set of log data. Cloud components (such as cloud components 722, 724 and 726—also sometimes herein referred to as “execution environments”) create and register search queries at workload placement router (WLP Router) 706. WLP Router 706 then indexes a representation of the search queries associated with the cloud components (such as cloud components 722, 724 and 726) in the registry search index (such as registry 704).

In some embodiments, WLP Router 706 receives a placement request and creates search query representations associated with the execution environments in the registry index (such as registry 704) such that adapted search query representations are higher than non-adapted search query representations. In some embodiments, WLP Router 706 issues resulting top-ranked search queries to ELK Stack 708 and Search API 710, and then receives the search results. Additionally, in some embodiments, WLP Router 706 sends placement requests to the target execution environment that is associated with the top ranked search result.

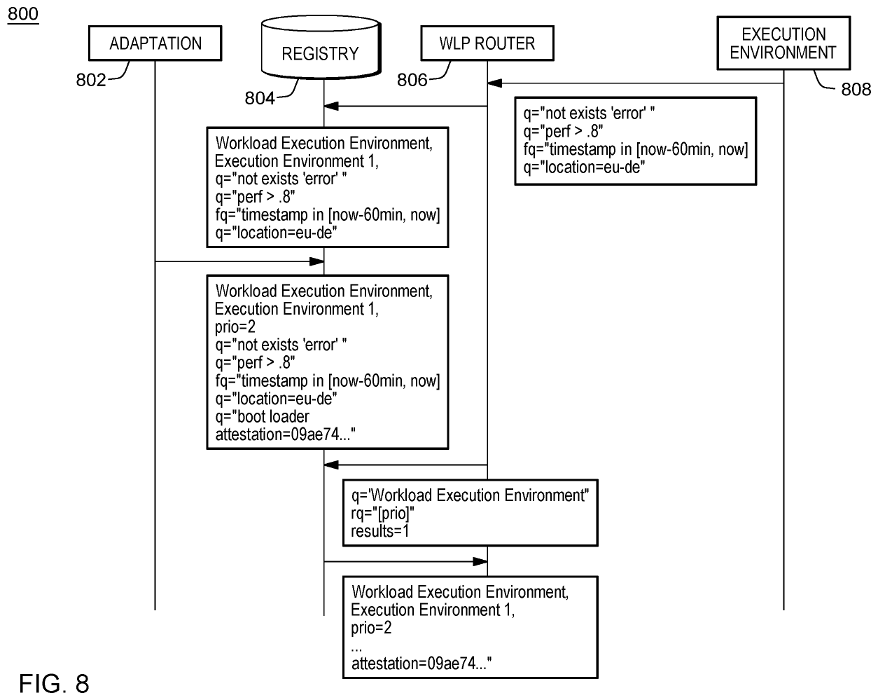

System flow diagram 800 of FIG. 8 depicts an extended workload placement mechanism. Diagram 800 includes: adaptation module 802, registry 804, WLP Router 806, and execution environment 808, and several instances of a workload execution environment operations (not separately labeled).

A method for routing a service request (that is, a service invocation request or a workload placement request) to a service instance is provided.

The operations of this method include the following (not necessarily in the following order): (i) determining a set of service instances (that is, the instances of a microservice or environment specific instances of a deployment service); (ii) associating at least one service instance with a set of search queries; (iii) determining at least one search index (representing the current system context, that can be built from logs); (iv) optionally adapting the search queries by the router in a context and tenant-specific way; (v) creating a set of search results (where each search result is associated with at least one service instance) by executing a (sub-) set of the service instance associated search queries on at least one search index (referenced above); (vi) selecting a set of service instances based on the search results (that is, the service instance which is associated with the search query resulting in the top-scored search results); and (vii) routing the service request to the selected service instance(s).

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above — similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

User/subscriber: includes, but is not necessarily limited to, the following: (i) a single individual human; (ii) an artificial intelligence entity with sufficient intelligence to act as a user or subscriber; and/or (iii) a group of related users or subscribers.

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output/report: unless otherwise explicitly specified, these words should not be taken to imply: (i) any particular degree of directness with respect to the relationship between their objects and subjects; and/or (ii) absence of intermediate components, actions and/or things interposed between their objects and subjects.

Without substantial human intervention: a process that occurs automatically (often by operation of machine logic, such as software) with little or no human input; some examples that involve “no substantial human intervention” include: (i) computer is performing complex processing and a human switches the computer to an alternative power supply due to an outage of grid power so that processing continues uninterrupted; (ii) computer is about to perform resource intensive processing, and human confirms that the resource-intensive processing should indeed be undertaken (in this case, the process of confirmation, considered in isolation, is with substantial human intervention, but the resource intensive processing does not include any substantial human intervention, notwithstanding the simple yes-no style confirmation required to be made by a human); and (iii) using machine logic, a computer has made a weighty decision (for example, a decision to ground all airplanes in anticipation of bad weather), but, before implementing the weighty decision the computer must obtain simple yes-no style confirmation from a human source.

Automatically: without any human intervention.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method (CIM) comprising:
determining a search index and a plurality of service instances based, at least in part, upon using a set of system state aware logs that includes information indicative of a current system state and a current system context;
associating a service instance of the plurality of service instances to at least one search query;
running the at least one search query against the search index, with the running of the at least one search query against the search index producing a scored search result;
responsive to the running of the at least one search query against the search index, selecting the search query producing the highest score; and
routing a service request to the service instance corresponding to the selected search query.

2. The CIM of claim 1 wherein the search index is built by ingesting a set of log data gathered from a plurality of data aggregators that are structured and configured to store and index data.

3. The CIM of claim 1 further comprising:
adapting, by a router subcomponent, the at least one search query by adding a filter query to limit the scope of the search query to a first tenant.

4. The CIM of claim 1 further comprising:
determining, by a router, all service instances that can be utilized to process the requested service;
determining, by the router, a set of search queries for each of the service instances selected to process the requested service; and
issuing, by the router, the set of search queries against the determined search index.

5. The CIM of claim 1 wherein the search query producing the highest score being indicative of a database with the fewest errors for processing the service instance.

6. The CIM of claim 1 further comprising:
running a second instance of the at least one search query against the search index, with the running of the second instance of the at least one search query producing a second scored search result;
responsive to the running of the second instance of the at least one search query against the search index, selecting the search query producing a re-ranked highest score; and
routing the service request to the service instance corresponding to the selected search query.

7. A computer program product (CPP) comprising:
a computer readable storage medium; and
computer code stored on the computer readable storage medium, with the computer code including instructions and data for causing a processor set to perform operations comprising:
determining a search index and a plurality of service instances based, at least in part, upon using a set of system state aware logs that includes information indicative of a current system state and a current system context,
associating a service instance of the plurality of service instances to at least one search query,
running the at least one search query against the search index, with the running of the at least one search query against the search index producing a scored search result,
responsive to the running of the at least one search query against the search index, selecting the search query producing the highest score, and
routing a service request to the service instance corresponding to the selected search query.

8. The CPP of claim 7 wherein the search index is built by ingesting a set of log data gathered from a plurality of data aggregators that are structured and configured to store and index data.

9. The CPP of claim 7 with the instructions and data further causing the processor set to perform operations comprising:
adapting, by a router subcomponent, the at least one search query by adding a filter query to limit the scope of the search query to a first tenant.

10. The CPP of claim 7 with the instructions and data further causing the processor set to perform operations comprising:
determining, by a router, all service instances that can be utilized to process the requested service;
determining, by the router, a set of search queries for each of the service instances selected to process the requested service; and
issuing, by the router, the set of search queries against the determined search index.

11. The CPP of claim 7 wherein the search query producing the highest score being indicative of a database with the fewest errors for processing the service instance.

12. The CPP of claim 7 with the instructions and data further causing the processor set to perform operations comprising:
running a second instance of the at least one search query against the search index, with the running of the second instance of the at least one search query producing a second scored search result;
responsive to the running of the second instance of the at least one search query against the search index, selecting the search query producing a re-ranked highest score; and
routing the service request to the service instance corresponding to the selected search query.

13. A computer system (CS) comprising:
a processor set;
a computer readable storage medium; and
computer code stored on the computer readable storage medium, with the computer code including instructions and data for causing the processor set to perform operations comprising:
receiving a workload placement data set, with the workload placement data set including information indicative of a search index and a plurality of service instances,
associating a service instance of the plurality of service instances to at least one search query included in the search index,
running the at least one search query against the search index, with the running of the at least one search query against the search index producing a scored search query,
responsive to the running of the at least one search query against the search index, selecting the scored search query with the highest score, and
routing a service request to the service instance corresponding to the scored search query with the highest score.

14. The CS of claim 13 wherein the search index is built by ingesting a set of log data gathered from a plurality of data aggregators that are structured and configured to store and index data.

15. The CS of claim 13 with the instructions and data further causing the processor set to perform operations comprising:
adapting, by a router subcomponent, the at least one search query by adding a filter query to limit the scope of the search query to a first tenant.

16. The CS of claim 13 with the instructions and data further causing the processor set to perform operations comprising:
determining, by a router, all service instances that can be utilized to process the requested service;
determining, by the router, a set of search queries for each of the service instances selected to process the requested service; and
issuing, by the router, the set of search queries against the determined search index.

17. The CS of claim 13 wherein the search query producing the highest score being indicative of a database with the fewest errors for processing the service instance.

18. The CS of claim 13 with the instructions and data further causing the processor set to perform operations comprising:
running a second instance of the at least one search query against the search index, with the running of the second instance of the at least one search query producing a second scored search result;
responsive to the running of the second instance of the at least one search query against the search index, selecting the search query producing a re-ranked highest score; and
routing the service request to the service instance corresponding to the selected search query.
